(19) United States
(12) Patent Application Publication
(10) Pub. No.: US 2019/0310900 A1
(43) Pub. Date: Oct. 10, 2019

(54) SYSTEM, METHOD, AND COMPUTER-READABLE MEDIUM FOR ALLOCATING DIGITAL DATA PROCESSING SYSTEM RESOURCES

(71) Applicant: Shufl Inc., Toronto (CA)

(72) Inventors: John Jong Suk LEE, Toronto (CA); Julian Charles HALDENBY, Kitchener (CA); Perry Aaron Jones HALDENBY, Toronto (CA); Paul Mon-Wah CHAN, Markham (CA); Eythan D'AMICO, Toronto (CA)

(73) Assignee: Shufl Inc., Toronto (CA)

(21) Appl. No.: 16/376,434

(22) Filed: Apr. 5, 2019

Related U.S. Application Data
(60) Provisional application No. 62/653,758, filed on Apr. 6, 2018.

(51) Int. Cl. G06F 9/54; G06F 9/50; H04L 9/06

(52) U.S. Cl. CPC G06F 9/542; H04L 2209/38; H04L 9/0643; G06F 9/50

(57) ABSTRACT

A computer-implemented method for allocating resources includes identifying event conditions matched by events identified based on a monitoring of events associated with an account. Modifiers associated with the matched event conditions are retrieved. An account modifier is computed based on the modifiers. A selected quantity of resources is determined by modifying a base resource level based on the account modifier and allocated for use in association with the account. The allocating includes initiating a blockchain transaction to update a distributed ledger to indicate the quantity of resources in association with an address associated with the account. The events are associated with consumption of computing resources. The modifiers associated with particular event conditions are updateable based on a comparison of computing resources consumed by events matching the particular event conditions with a resource allocation for those events. Related systems and computer-readable media are also disclosed.

### FIELD

This relates to the task management and control and to the use of blockchains, and more particularly, to allocating digital data processing system resources using a blockchain.

### BACKGROUND

Some computer systems support multiple accounts. For example, a computer such as, for example, a distributed system made up of multiple computing devices may support accounts allowing access to the resources of the distributed system. Accounts may, for example, be associated with different users using the system and/or with different services provided by the system. Activity associated with accounts may consume computing resources. For example, activity may include or be associated with events that are associated with the consumption of computing resources.

Computing resources of any computer system are inherently a finite resource. In some computer systems, it may be desirable to allocate resources in an effort to direct their consumption. For example, it may be that particular events associated with a consumption of computing resources are to be favoured so as to promote utilization of a computer system to one or more particular ends. For example, tasks of a computer system may be managed and/or controlled through the allocation of computing resources.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2 is a high-level operation diagram of an example computing device;

FIG. 3 is a simplified block diagram illustrating components of an example system for allocating resources to accounts responsive to events; and

FIG. 4 is a flow chart illustrating example operations performed in allocating resources to an account responsive to events.

Like reference numerals are used in the drawings to denote like elements and features.

### DETAILED DESCRIPTION OF VARIOUS EMBODIMENTS

In one aspect, there may be provided a computer system. The computer system includes a processor, a network interface module, and a computer-readable medium. The computer system is a node participating in a blockchain network executing a smart contract. The computer-readable medium stores instructions that when executed by the processor, adapt the computer system to identify, from amongst a plurality of event conditions, event conditions matched by events associated with an account, the events having been identified based on a monitoring of events associated with the account. The instructions, when executed by the processor, further adapt the computer system to retrieve modifiers associated with the matched event conditions and to compute an account modifier based on the retrieved modifiers. The instructions, when executed by the processor, further adapt the computer system to allocate a selected quantity of resources for use in association with the account. The selected quantity of resources is determined by modifying a base resource level based on the account modifier. The allocating may include initiating a blockchain transaction to update a distributed ledger to indicate the selected quantity of resources in association with an address associated with the account. One or more of the events are associated with consumption of computing resources. The modifiers associated with particular event conditions are updateable based on a comparison of computing resources consumed by events matching the particular event conditions with a resource allocation for those events.

In some implementations, the instructions when executed by the processor further adapt the computer system to detect a previously defined consumption of computing resources, to identify one or more events associated with the previously defined consumption of computing resources, and to adjust modifiers associated with event conditions matching the one or more events associated with the previously defined consumption of computing resources.

In some implementations, adjusting modifiers associated with event conditions matching one or more events associated with the previously defined consumption of computing resources includes adjusting at least one of the modifiers to a fractional value.

In some implementations, the retrieved modifiers are multipliers.

In some implementations, computing the account modifier based on the retrieved modifiers includes computing a product of the retrieved modifiers.

In some implementations, the events associated with the account are events that occurred since a last allocation of resources for use in association with the account and the account modifier is further computed based on modifiers associated with event conditions matched by events prior to the last allocation of resources.

In some implementations, each of the retrieved modifiers has an associated activation period and the account modifier is computed based on ones of the retrieved modifiers that are active based on their respective activation periods.

In some implementations, at least one of the retrieved modifiers is a positive, non-zero value.

In some implementations, one or more event conditions matching events associated with a previously defined consumption of computing resources have associated modifiers with fractional values.

In some implementations, one or more event conditions matching events associated with a previously defined consumption of computing resources have associated modifiers with values greater than or equal to one.

In some implementations, information about events associated with the account is retrieved from a remote computing device via a network using the network interface module.

In another aspect, there may be provided a computer-implemented method. The method is performed by a node participating in a blockchain network executing a smart contract. The computer-implemented method includes identifying, by a processor of a computing device from amongst a plurality of event conditions, event conditions matched by events associated with an account, the events having been identified based on a monitoring of events associated with the account; retrieving modifiers associated with the matched event conditions; computing, by the processor, an account modifier based on the retrieved modifiers; and allocating a selected quantity of resources for use in association with the account. The selected quantity of resources is determined by modifying a base resource level based on the account modifier. It may be that allocating the selected quantity of resources includes initiating a blockchain transaction to update a distributed ledger to indicate the selected quantity of resources in association with an address associated with the account. One or more of the events are associated with consumption of computing resources. The modifiers associated with particular event conditions are updateable based on a comparison of computing resources consumed by events matching the particular event conditions with a resource allocation for those events.

In some implementations, the method further includes detecting a previously defined consumption of computing resources; identifying one or more events associated with the previously defined consumption of computing resources; and adjusting modifiers associated with event conditions matching the one or more events associated with the previously defined consumption of computing resources.

In some implementations, adjusting modifiers associated with event conditions matching the one or more events associated with the previously defined consumption of computing resources includes adjusting at least one of the modifiers to a fractional value.

In some implementations, the retrieved modifiers are multipliers.

In some implementations, computing the account modifier based on the matched event conditions includes computing a product of the retrieved modifiers.

In some implementations, the events associated with the account are events that occurred since a last allocation of resources for use in association with the account and the account modifier is further computed based on modifiers associated with event conditions matched by events prior to the last allocation of resources.

In some implementations, each of the retrieved modifiers has an associated activation period and the account modifier is computed based on ones of the retrieved modifiers that are active based on their respective activation periods.

In some implementations, one or more of the retrieved modifiers is a positive, non-zero value.

In some implementations, one or more event conditions matching events associated with a previously defined consumption of computing resources have associated modifiers with fractional values.

In some implementations, one or more event conditions matching events associated with a previously defined consumption of computing resources have associated modifiers with values greater than or equal to one.

In another aspect, there may be provided a non-transitory computer-readable storage medium storing instructions that, when executed by a processor of a computing device, cause the computing device to perform the foregoing method.

In another aspect, there may be provided a non-transitory computer-readable storage medium storing instructions that, when executed by a processor of a computing device that is a node participating in a blockchain network executing a smart contract, cause the computing device to: identify, from amongst a plurality of event conditions, event conditions matched by events associated with an account, the events having been identified based on a monitoring of events associated with the account; retrieve modifiers associated with the matched event conditions; compute an account modifier based on the retrieved modifiers; and allocate a selected quantity of resources for use in association with the account, wherein the selected quantity of resources is determined by modifying a base resource level based on the account modifier, the allocating including initiating a blockchain transaction to update a distributed ledger to indicate the selected quantity of resources in association with an address associated with the account, wherein one or more of the events are associated with consumption of computing resources and wherein the modifiers associated with particular event conditions are updateable based on a comparison of computing resources consumed by events matching the particular event conditions with a resource allocation for those events.

In another aspect, there may be provided a system. The system includes a first computer system adapted for monitoring events associated with accounts to identify events associated with the accounts, at least some of the events associated with the accounts are events occurring on a blockchain. The system also includes a second computer system in communication with the first computer system via a network and participating in a blockchain network executing a smart contract. The second computer system is adapted for periodically accruing resources in association with the accounts by, for a particular one of the accounts in a given period: identifying, from amongst a plurality of event conditions, event conditions matched by events associated with a particular account; computing a multiplier product based on multipliers associated with the matched event conditions; and accruing a resource for the given period in association with the particular account using a blockchain transaction updating a distributed ledger to reflect accrual of the resource to an address associated with the particular account. The resource is a product of a base resource amount for the given period and the multiplier product.

In some implementations, the events associated with the particular account are events that occurred since a resource was accrued for a previous period and the multiplier product is further based on multipliers associated with event conditions matched in one or more previous periods.

In some implementations, each of the multipliers has an associated activation period and the multiplier product is determined based on ones of the multipliers that are active based on their respective activation periods.

In some implementations, at least one of the multipliers is a positive, non-zero value.

In some implementations, ones of the event conditions matched by undesired events have an associated multiplier having a value less than one.

In some implementations, ones of the event conditions matched by desired events have an associated multiplier having a value greater than one.

In another aspect, there may be provided a computer-implemented method performed by a server participating in a blockchain network executing a smart contract. The method includes identifying, from amongst a plurality of event conditions, event conditions matched by events associated with a particular account, the events having been identified based on a monitoring of events associated with the particular account and at least some of the events associated with the accounts being events occurring on a blockchain; computing a multiplier product based on multipliers associated with the matched event conditions; and accruing a resource for a period in association with the particular account using a blockchain transaction updating a distributed ledger to reflect accrual of the resource to an address associated with the particular account. The resource is a product of a base resource amount for the period and the multiplier product.

In some implementations, the events associated with the particular account are events that occurred since a resource was accrued for a previous period and the multiplier product is further based on multipliers associated with event conditions matched in one or more previous periods.

In some implementations, each of the multipliers has an associated activation period and the multiplier product is determined based on ones of the multipliers that are active based on their respective activation periods.

In some implementations, at least one of the multipliers is a positive, non-zero value.

In some implementations, ones of the event conditions matched by undesired events have an associated multiplier having a value less than one.

In some implementations, ones of the event conditions matched by desired events have an associated multiplier having a value greater than one.

In another aspect, there may be provided a non-transitory computer-readable storage medium storing instructions that, when executed by a processor of a computer system, cause the computer system to perform the foregoing method.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

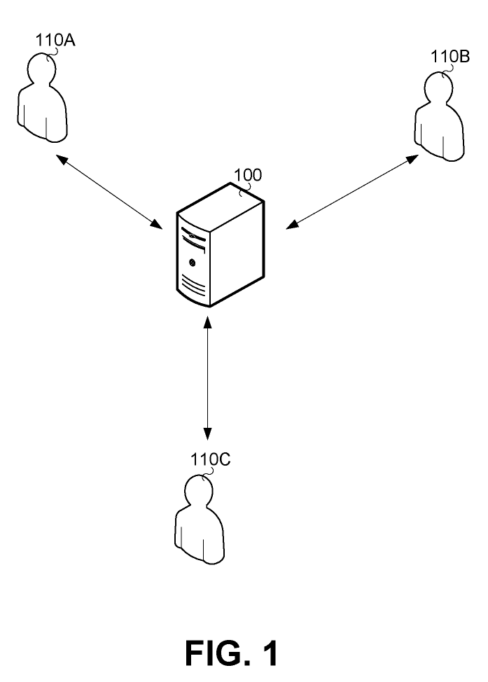

FIG. 1 is a schematic diagram illustrating an operating environment of an example embodiment.

As illustrated a computer system 100 may provide services to a plurality of users including, as shown, a user 110A, a user 110B, and a user 110C.

The computer system 100 is adapted for performing a computing workload including various tasks. The computer system 100 may, for example, be a computer device such as, for example, a mainframe computer, a microcomputer, a minicomputer, or the like. The computer system 100 may include one or more computing devices. For example, the computer system 100 may be a distributed system formed of a plurality of computing devices cooperating via a communications medium such as, for example, a computer network in order to complete the various tasks. In a particular example, the computer system 100 may be a cluster formed of various computing devices. Additionally or alternatively, the computer system 100 may include multiple computing devices such as, for example, database servers, storage servers, compute servers, and the like such as may, for example, be in communication via a communications medium such as, for example, a computer network. In some embodiments, the computer system 100 may include multiple computing devices organized in a tiered arrangement. For example, a computer system may include middle-tier and back-end computing devices.

Each of the users 110A-110C may use the computer system for performing various tasks. One or more of the users 110A-100C may be associated with a human user. Additionally or alternatively, one or more the users 110A-110C may correspond to a service such as may execute on the computer system 100 and/or on another computer system (not shown) such as may utilize the computer system 100 for performing tasks in support of the service. In a particular example, one the users 110A-110C may correspond to a print server or a web server. A respective account may be associated with each of the users 110A-110C.

The computer system 100 may have various associated computing resources such as, for example, storage, bandwidth, CPU cycles, memory space, and the like. Such computing resources are all finite. That is, inherent to any computer system providing computing resources, including the computer system 100, is that the associated computing resources are finite.

Tasks performed by the computer system 100 may be associated with one or more user accounts. Tasks may be associated with one or more events. Events may, therefore, be associated with one or more user accounts such as, for example, ones of the accounts associated with the users 110A-110C. Events (and tasks) may be associated with the consumption of computing resources. Consumption of computing resources in association with particular events may, therefore, be associated with one or more user accounts associated with those particular events. In other words, for a given time period during which particular events occurs, a particular account of the computer system 100 may be associated with consumption of a particular quantity of computing resources based on a monitoring of events associated with the particular account. Notably, therefore, various ones of the user accounts of the computer system 100 may, in a given period, consume a portion of the finite resources of the computer and the amount of consumption by a given user account may depend on the number and type of events during that time period that are associated with that user account.

The computer system 100 may be intended for accomplishing tasks associated with one or more purposes or workloads. For example, it may be that each of the tasks is intended to further one or more purposes and/or perform processing necessary to handle one or more workloads. Events may be generated by or based on particular tasks being performed by the computer system 100.

Some of those purposes or workloads may be favored over others of those purposes or workloads. It may be that a particular one of the purposes or workloads is to be favored so as to maximize throughput thereof. For example, one of the purposes or workloads may be favored so as to allow tasks associated therewith to be completed in real-time or near real-time.

Additionally or alternatively, it may be that a particular one or the purposes or workloads may be favored so as to provide suitable performance such as, for example, to tasks interacting with users (i.e., interactive tasks).

In yet another example, it may be that each of the various tasks associated with the various purposes or workloads are possible uses of the computer system 100, but, all things being equal, some tasks correspond to uses that should be favored with further resources (for example, such a task may be considered beneficial to an intended purpose) whereas some other tasks may correspond to uses that should not accrue further resources or that should be throttled (for example, such a task may be considered as consuming resources such as, for example, computing resources, such as could be considered contrary to an intended purpose).

Notably, because events correspond to tasks, it may that favoring (or disfavoring) tasks associated with particular purposes or workloads involves favoring tasks based on events associated therewith. As further described below, embodiments according to the present application may periodically allocate resources to accounts, with accounts being allocated a base amount of resources subject to adjustment for modifiers identified based on particular events associated with the account.

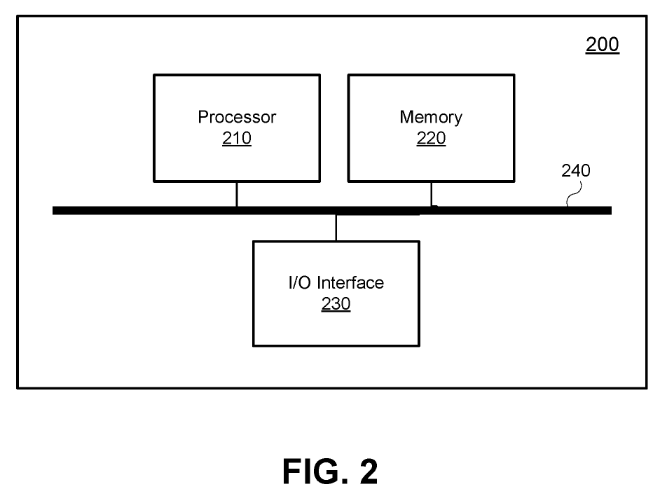

The computer system 100 may, as noted above, take a variety of forms. FIG. 2 is a high-level operation diagram of an example computing device 200. In some implementations, example computing device 200 may be exemplary of the computer system 100 or one or more computing devices forming the computer system 100.

The example computing device 200 includes a variety of modules. For example, as illustrated, the example computing device 200 may include a processor 210, a memory 220, an input/output (I/O) interface 230. As illustrated, the foregoing example modules of the example computing device 200 are in communication over bus 240.

The processor 210 is a hardware processor. The processor 210 may, for example, be one or more Intel ×86, PowerPC, or ARM processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The I/O interface 230 allows the example computing device 200 to interface with other devices such as, for example, peripherals. In one example, the I/O interface 230 may be in communication with or may include a display adapter for controlling a video display (not shown). Additionally or alternatively, the I/O interface 230 may be in communication with or may include a network interface module for communicating with a computer network (not shown). Additionally or alternatively, the I/O interface 230 may interface with one or more input device such as, for example, a mouse, a keyboard, or the like (not shown). In some implementations, the I/O interface 230 may communicate with a variety of external devices and may, for example, communicate with or include a universal serial bus (USB) interface (not shown). The foregoing are examples and the I/O interface may additionally or alternatively communicate with other peripherals, devices, data sources, and the like (not shown).

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

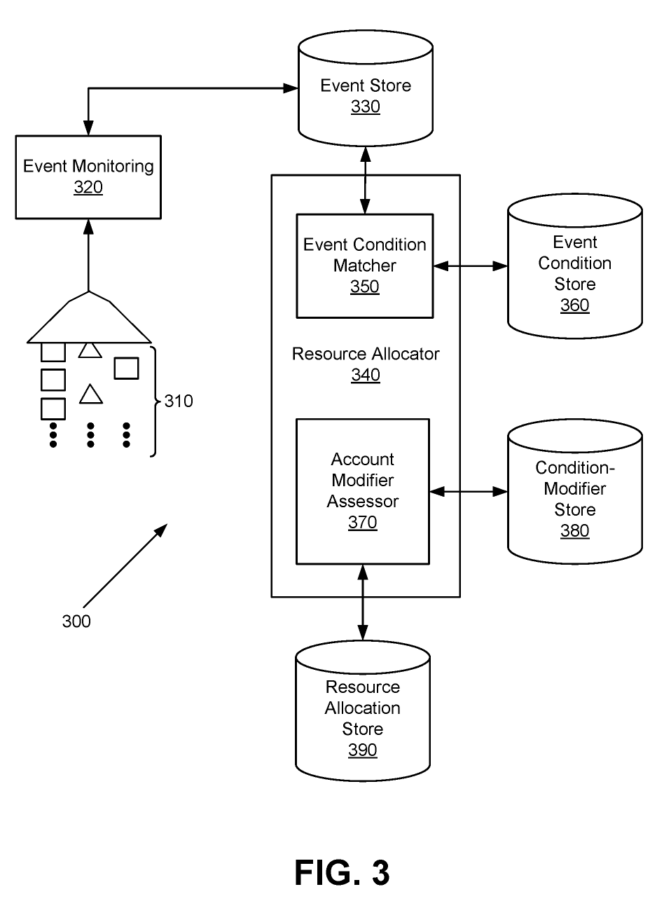

FIG. 3 is a simplified block diagram illustrating components of an example system for allocating resources to accounts responsive to events. In particular, FIG. 3 illustrates the interaction between components of a resource allocation system 300.

As illustrated, events 310 may be received by an event monitoring component 320. As further explained below, the event monitoring component 320 examines the events 310 and generates corresponding data about those events. The data is stored in an event store 330.

The event store 330 is accessed by a resource allocator component 340. The resource allocator component 340 may operate asynchronously of the event store 330. For example, the resource allocator component 340 may periodically communicate with the event store 330 to identify events that occurred since a prior period. In this way, resources may be periodically allocated for accounts based on events. The length of a period may be established for a particular implementation taking into account factors relevant to that implementation. For example, establishing a period length may take into account, for example, a trade-off between the computing overhead of the resource allocation system 300 and latency in the allocation of resources. In some implementations, the period may be established based on a suitable unit of wall-clock or calendar time such as, for example, 1 day, 1 hour, 1 minute, 15 minutes, 30 minutes, or 30 seconds.

The resource allocator component 340 may include various subcomponents. For example, as illustrated, the resource allocator component 340 may include an event condition matcher subcomponent 350 and an account modifier assessor subcomponent 370.

The event condition matcher subcomponent 350 interacts with an event condition store 360 to identify event conditions matched by events. Based on the matched event conditions, the account modifier assessor subcomponent 370 computes an account modifier based on modifiers associated with the matched conditions such as may be retrieved from a condition-modifier store 380. As further explained below, the account modifier assessor subcomponent 370 may then allocate a selected quantity of resources for use in associated with accounts based on a base resource level for a period which is adjusted for each account receiving such an allocation according to the determined modifier for that account. A record of resources allocated may be stored in a resource allocation store 390. For example, the resource allocation store 390 may maintain a measure of resources associated with each account of the computer system 100. In a particular example, the resource allocation store 390 may maintain balances reflecting unused resources associated with accounts of the computer system 100.

The resource allocation store 390 may also be accessed by other components (not shown). For example, other components may also operate on the above-mentioned balances such as, for example, to reduce them balances as allocated resources are consumed. Additionally or alternatively, in some implementations, balances may be reduced by the resource allocator component 340 based on the events 310 such as, for example, based on the contents of the event store 330.

The event monitoring component 320, the resource allocator component 340, the event condition matcher subcomponent 350, and the account modifier assessor subcomponent 370 correspond to software comprising instructions as may be executed by a processor of a computer system from a computer-readable medium. For example, one or more of the components may execute on a processor of the computer system 100. In a particular example, such as, for example, when the computer system 100 is a suitably configured instance of the example computing device 200, it may be that one or more of the components are software stored in the memory 220 of the example computing device 200 and executed therefrom by the processor 210. In another example, it may be that various ones of the components are software running on more than one computer system such as may communicated thereamongst and/or with the computer system 100 via a computer network (not shown). In a particular example, a first computer system may be adapted for monitoring events associated with accounts to identify events associated with the accounts and may provide some or all of the functionality of the event monitoring component 320. A second computer system may be in communication with such a first computer system such as, for example, by way of a network. The second computer system may be adapted for periodically accruing resources in association with the accounts and may provide some or all of the functionality of the resource allocator component 340. For example, such a second computer system may provide some or all of the functionality of one or both of the event condition matcher subcomponent 350 and the account modifier assessor subcomponent 370.

Each of the above-mentioned stores—the event store 330, the event condition store 360, the condition-modifier store 380, and the resource allocation store 390—may take a variety of forms. For example, it may be that one or more of the stores corresponds to a database. Additionally or alternatively, one or more of the stores may be portions of an overall store. In a particular example, various of the stores may correspond to tables of one or more databases. Conveniently, where various of the stores correspond to tables in one or more databases, various of the operations described herein relative those stores may be implemented via and/or may correspond to one or more queries in a database and/or one or more distributed cross-database queries.

Events 310 may be associated with various of the tasks performed using the computer system 100. Additionally or alternatively, events 310 may arise from other sources. For example, events may arise from other computer systems across which resources are being allocated as a group (for example, rather than on a per computer system basis). In a particular example, such event conditions may be retrieved from a remote computing device via a network (not shown) such as may be accessed, for example, by way of a network interface module of the computer system 100. For example, information about events associated with a particular account may be so received. It may be that, as illustrated, the events 310 may include events of different types. Notably, events of different types may arrive at different frequencies. Some of the events 310 may occur at a specified periods or frequencies such as, for example, events reflective of a current state of the computer system 100 as may be periodically assessed or measured. Others of the events 310 may occur from time-to-time such as, for example, responsive to tasks performed by the computer system 100 and/or activities such as may be associated with one or more of the accounts of the computer system 100.

The event monitoring component 320 may consider each of the events 310 and log it to an event store 330. For example, if the event store 330 is a database, a record may be created corresponding to each of the events 310.

As noted above, events may correspond to a particular account. Accordingly, entries in the event store 330 may associate events with an account. Additionally or alternatively, events may be associated with a time or time period within which they occur.

Additionally or alternatively, events may be aggregated in some way such as, for example, by computing one or more statistical measures of events. Event processing may be performed and logged in association with successive discrete segments of time. In some implementations, aggregation of events may occur across such a segment of time (i.e., a period). For example, the event monitoring component 320 may determine a count of a particular type of event occurring in a period. In another example, the event monitoring component 320 may compute average numbers of events of a certain type or types occurring in a given period. Additionally or alternatively, the event monitoring component 320 may aggregate across periods. For example, the event monitoring component may compute a moving average of events of particular types across a chosen number of successive periods. In another example, a total number of events such as, for example, a total of events of a particular type or, in another example, an overall total of events in a period, may be calculated.

As mentioned above, the event monitoring component 320 may insert and/or maintain data stored in the event store 330. Data stored in the event store 330 may be accessed by the event condition matcher subcomponent 350.

In some implementations, the event monitoring component 320 may monitor and generate/maintain data in the event store 330 reflective of all of the events 310. Additionally or alternatively, the event monitoring component 320 may filter the events 310 before generating records in the event store 330. Conveniently, filtering the events 310 may reduce the computing resource overhead associated with maintaining the event store 330 and, therefore, with the resource allocation system 300. In some implementations, the event filtering may be based on the events as will be considered by the event condition matcher subcomponent 350. For example, it may be that the event condition matcher subcomponent 350 identifies events that should be monitored by the event monitoring component 320. In another example, the event monitoring component 320 may access the event condition store 360 to determine events that should be monitored. In yet another example, the event monitoring component 320 may subscribe to events such as, for example, based on the contents of the event condition store 360. In some implementations, the event condition matcher subcomponent 350 may receive periodic notifications from one or both of the event monitoring component 320 and the event store 330 for subscribed events.

The event condition store 360 stores conditions as may be matched by one or more of the events 310 and/or aggregations thereof. The event condition matcher subcomponent 350 may query the event store 330 to determine which of the event conditions stored in the event condition store 360 are matched by events. For example, the event condition matcher subcomponent 350 may identify from amongst the plurality of event conditions stored in the event condition store 360, event conditions matched by events associated with accounts. In a particular example, the event condition matcher subcomponent 350 may, for an account, identify event conditions matched by events associated with the account. Such event conditions may be matched by particular ones of the events 310 having been identified based on the monitoring of events associated with that account such as may be monitored by the event monitoring component 320 and may be stored in the event store 330.

Based on the matched event conditions identified by the event condition matcher subcomponent 350, the resource allocator component 340 may retrieve modifiers associated with the matched event conditions. For example, the modifiers may be retrieved by the account modifier assessor subcomponent 370 from the condition-modifier store 380. At least some different types of events may be associated with different modifiers. For example, one type of event may have a modifier that is greater than a modifier associated with another type of event.

Based on the retrieved modifiers, the account modifier assessor subcomponent 370 may compute an account modifier based on the retrieved modifiers. For example, it may be that the retrieved modifiers are multipliers. Accordingly, it may be that computing the account modifier based on the retrieved modifiers includes computing a product of the retrieved modifiers. In a particular example, it may be that each of the retrieved modifiers is a positive, non-zero value. For example, it may be that event conditions matching events associated with a previously defined consumption of computing resources have associated multipliers with fractional values.

Additionally or alternatively, it may be that one or more of the modifiers has an associated activation period. For example, it may be that each of the modifiers has an associated activation period. Additionally or alternatively, it may be that a particular modifier has a value based on the particular period. In a particular example, a modifier associated with a particular event condition may have one value for events occurring in one period and another value for events occurring in another period. Additionally or alternatively, modifiers corresponding to event conditions matched in a particular period may continue to affect the account modifier in one or more subsequent periods. For example, it may be that each multiplier, once triggered by an event condition, is associated with an account for a particular period starting from a selected activation time. Additionally or alternatively, it may be that modifiers decay according to some decay model such as, for example, a linear or exponential decay model. In some implementations, it may be that parameters of such a decay model are determined based on one or more other events such as may, for example, be matched by one or more event conditions. The account modifier may be computed based on ones of the modifiers that are active such as, for example, based on their respective activation periods.

As explained above, it may be that events considered for matching against event conditions are events that occurred or were recognized in a current period (i.e., since a previous period/the last allocation of resources for use in association with a particular account). As such modifiers included in computing the account modifier (e.g., the modifiers retrieved for the matched event conditions) include modifiers associated with event conditions matched by events that occurred in a current period. Additionally, however, modifiers included in computing the account modifier for a particular account may include modifiers associated with events that occurred in one or more previous periods (i.e., modifiers associated with event conditions that were matched by events that occurred in one or more previous periods). For example, modifiers included in computing the account modifier for a particular account may include modifiers for account conditions matched in one or more previous periods. In a particular example, where the modifiers considered in determining the account modifier are multipliers and the account modifier is a product of those multipliers, that multiplier product may be further based on multipliers associated with event conditions matched in one or more previous periods.

Based on the account modifier, a selected quantity of resources may be allocated for use in association with the particular account. For example, such an allocation may be reflected in data stored in the resource allocation store 390 such as was described above. The selected quantity of resources may be determined by modifying a base resource level based on the account multiplier. For example, the account modifier may be a multiplier such as, for example, when the retrieved modifier is a multiplier. Conveniently, where the account modifier is a multiplier, the selected quantity of resources may be computed by multiplying the base resource value by the account modifier. In other words, it may be that the base resource level is a base resource amount that is adjusted by multiplying it by the account modifiers. Notably where the account modifier for a particular account for a period has a value of less than 1, the allocated quantity of resources for that account for that period will be less than the base resource level. By contrast, where the account modifier for a particular account for a period has a value of greater than 1, the allocated quantity of resources for that account for that period will be greater than the base resource level.

As mentioned above, each of the events 310 may be associated with a consumption of finite computing resources of the computer system 100 and it may be necessary to direct allocation of those resources such as, for example, in manners as to give preference to particular aspects of the workload of the computer system 100 over other aspects of the workload of the computer system 100.

Event conditions matched by a previously defined consumption of computing resources may be selected to have a particular effect on the account modifier when matched. For example, it may be that such an event condition has an associated modifier with a fractional value (0<×<1) or, alternatively with a value greater than (or equal to) (×≥1). In a first particular example, it may be that one or more event conditions matched by undesired events such as, for example, events associated with a previously defined consumption of computing resources considered undesirable, have associated modifiers with fractional values (0<×<1) such as, for example, where the modifiers are multipliers. Conveniently, in this way the account modifier may be reduced. Reducing the account modifier may reduce the allocate of resources to the corresponding account. A previously defined consumption of computing resources could be considered undesirable if, for example, it exceeds a level so as to be considered excessive. In another example, it may be that one or more event conditions matched by desired events such as, for example, events associated with a previously defined consumption of computing resources considered desirable, have associated modifiers with values greater than (or equal to) one (×≥1) such as, for example, where the modifiers are multipliers. Conveniently, in this way the account modifier may be increased. Increasing the account modifier may reduce the allocate of resources to the corresponding account. A previously defined consumption of computing resources could be considered desirable if, for example, it does not exceed a particular level.

Conveniently, the modifiers associated with event conditions (e.g., as stored in the condition-modifier store 380) may be mutable (i.e., adjustable). In particular, the modifiers associated with particular event conditions may be updateable based on conditions such, as, for example a comparison of computing resources consumed by events matching particular event conditions with a resource allocation for those events. For example, where the consumption of resources associated with events matching particular event conditions is exceeds a previously defined consumption, the modifier may be adjusted such as, for example, by reducing a value of the modifier. In a particular example, where modifiers are multipliers, modifiers associated with event conditions matching one or more events associated with an exceeding a previously defined consumption of computing resources may include adjusting at least one of the modifiers to a fractional value. Conveniently, in this way, the resources allocated to corresponding ones of the accounts may be reduced.

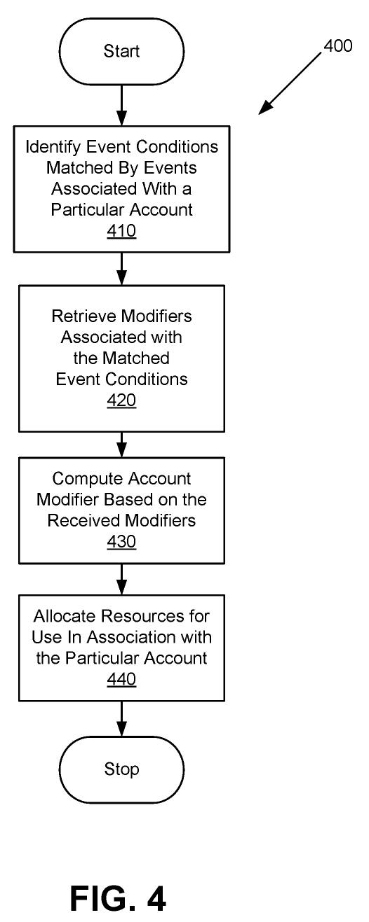

FIG. 4 shows a flow chart 400 illustrating example operations performed in allocating resources to an account responsive to events. For example, the operations illustrated in the flow chart 400 may correspond to operations performed by one or more of the event monitoring component 320 and the resource allocator component 340, with the operations performed by the latter including the event condition matcher subcomponent 350 and the account modifier assessor subcomponent 370 as described above.

In the flow chart 400, operations 410 and onward are performed by one or more processors of one or more computing devices. For example, the operations 410 and onward may be performed by a processor of the computer system 100. In a particular example, where the computer system 100 is a suitably configured implementation of the example computing device 200, the operations may be performed by the processor 210 executing software comprising computer-executable instructions as may be stored in a computer-readable medium such as, for example, storage of the memory 220.

At the operation 410, event conditions matched by events associated with a particular account are identified from amongst a plurality of event conditions. For example, it may be that the plurality of event conditions is stored in the event condition store 360 and matching ones thereof are identified from the event store 330 such as in manners described above. The events may have been identified based on a monitoring of events associated with the particular account such as, for example, by way of the event monitoring component 320 as described above.

From the operation 410, control flow advances to an operation 420.

At the operation 420, modifiers associated with the event conditions matched at the operation 410 are retrieved. For example, the matching modifiers may be retrieved from the condition-modifier store 380 in manners as described above.

From the operation 420, control flow proceeds to an operation 430.

At the operation 430, an account modifier is computed based on the modifiers retrieved at the operation 420. An account modifier may, for example, may be computed in manners as described above.

From the operation 430, control flow proceeds to an operation 440.

At the operation 440, resources are allocated for use in association with the particular account. For example, an allocation of resources may be reflected for the particular account in the resource allocation store 390 such as in manners described above.

From the operation 440, control flow stops as regards the particular account. Control flow may later return to the operation 410 such as, for example, for allocating resources in association with another account and/or for allocating resources in association with the particular account for a later period. Additionally or alternatively, operations of the flow chart 400 may be performed for more than one account in parallel so as to allow allocating resources in association with each of those particular accounts. Additionally or alternatively, operations of the flow chart 400 may be performed for various accounts in series again so as to allow allocating resources in association with various accounts.

Systems consistent with the foregoing may be suitable for allocating resources in a computing device. Other applications are also possible. For example, it may be that the events associated with the particular account may correspond to activity beyond the computer system 100. Accordingly, resources may be allocated responsive to such activity consistent with the foregoing. In another example, it may be that impacts or consumptions of other resources beyond the consumption of computing resources are associated with an event. Conveniently, the subject matter of the present application may be employed to allocate resources further to such consumption and/or to adjust the allocation of resources further to such consumption in manners consistent with the foregoing. In a particular example, the resources allocated may be viewed as rewards (or penalties) for particular activity or events associated with an account that are matched by corresponding event conditions. For example, it may be that some or all of the events correspond to activity by a user associated with an account. The resources allocated may, additionally or alternatively, also be or include resources other than computing resources such as, for example, various other resources having value in a particular context.

In a particular example, the subject matter of the present application may be employed to allocate resources further to user activity in an online system. For example, it may be that resources are allocated based on events corresponding to one or more of creation of an account in an online forum or website, a number of posts to the online forum or website, a number of listings or a number of transactions or trades via the online forum or website (e.g. where the forum or website is an online marketplace), etc. In a particular example, users (i.e., accounts associated with users) may, for example, be allocated resources such as, for example, tokens as a reward for desired online activity/behavior. Additionally or alternatively, users may, for example, be denied resources (i.e., allocated a lower amount than a base amount or a lower amount than an amount they may have already warranted based on their activity.

In some embodiments, activity associated with accounts may be monitored to generate events and/or tasks associated with such activity may generate corresponding events. In a particular example, where an online forum or marketplace is provided, it may be that monitoring of activity is provided by the same computer system(s) as are responsible for providing the corresponding website(s). Additionally or alternatively, it may be a computer providing a graphical user interface (GUI) may generate events corresponding to user interactions. For example, if a GUI is provided via a website, the client and/or the server may generate events and/or may cooperate to generate same.

In some embodiments, modifiers associated with particular event conditions may be updated based on aggregated user activity being detected as corresponding to undesired activity. For example, it may be that an unexpected number of events of particular types are being generated in association with a particular account or across one or more groups of accounts. In a particular example, it may be that such activity is detected as fraud or an attempt to “game” the rewards allocation to obtain an unintended allocation. Conveniently in such cases, modifiers may be automatically adjusted or tweaked correspondingly. For example, it may be that the modifiers are reduced by way of feedback control until the undesired activity is averted. In another example, it may be that one or more additional event conditions are added (or activated) based on detection of such conditions. In a particular example, it may be that particular event conditions correspond to events corresponding to detection of such conditions. For example, it may be that event conditions are adapted to be matched by an event as may be injected into the system (potentially by an additional monitoring component) responsive to detection of such conditions (e.g., conditions of undesired activity such as, for example, perceived or detected fraud or attempts to “game” the resource allocation).

In some implementations, the operator of the system may allow third-parties to set-up rules or event conditions. For example, it may be that a third-party is permitted to set-up rules or event conditions that allocate resources from a pool provided, in whole or in part by, that third party. Conveniently, in this way, a third-party may be permitted to participate in resource allocation. This may, in turn, allow decentralization of the provision of resources. Additionally or alternatively, third-parties may top up or contribute to an existing pool of resources such as, for example, a pool as may be controlled by an operator of the system such as described above. For example, it may be that the operator agrees to configure event conditions favored by a third-party in exchange for such a contribution to or of a resource pool.

In some implementations, resources may be allocated each period for all accounts. In other implementations, only selected ones of the accounts may be allocated resources. For example, it may be that resources are only allocated for accounts that were active in that period or one of a number of previous periods, such as, for example, the last two or three periods.

In some implementations, event conditions may only be matched by events of a particular type if data or metadata about the event matches. For example, it may be that an event condition is only matched by a particular event if it occurs at a chosen wall-clock time or within a particular period. This may, for example, allow peak periods of use to be taken into account in determining whether particular activity associated with an event is favored or disfavored. For example, it may be that particular workloads are preferred to execute in off-peak times and the event condition serves to favour or disfavor events associated with those workloads based on when the events occur. In another example, where events are associated with external activity, data or metadata may be provided related to where the event occurred (i.e., a location). This may, for example, allow event conditions to only match particular events if they occur within a particular location or within a particular defined area (“geofence”). Conveniently, in this way, third-parties could define event conditions only matching events that occur in particular areas or locations, such as, for example, areas or locations associated with the third-party. For example, this may allow them to ensure their contributed resources are only allocated to events occurring in locations they select. Additionally or alternatively, a third-party may negotiate with an operator to disfavor events occurring in or in association with particular locations. For example, this may allow contributed resources to be denied to accounts associated with activities occurring in or in association with competitors' locations. Additionally or alternatively, metadata associated with events could reflect computer systems associated with those events and event conditions could be configured to favor or disfavor events associated with particular computer systems in manners similar to as described for locations.

It may be that the traceability or accountability of the allocation of resources is desired. For example, such a need may arise in the context of a particular application of the subject matter of the present application. In another example, it may be that such a need may be motivated by the nature of the resources being allocated such as, for example, where some or all of the resources being allocated have a market value such as, for example, transferable computing resources or digital currencies.

Traceability or accountability may be provided through implementations consistent with the present application that employ a blockchain. A blockchain is a list of records that are linked together using cryptography so as to resist or prevent tampering. An example of a blockchain is the Bitcoin blockchain. Another example of a blockchain is the Ethereum blockchain. The Ethereum blockchain is described in the Ethereum Yellow Paper, “Ethereum: A Secure Decentralized Generalised Transaction Ledger” by Dr. Gavin Wood, available https://ethereum.github.io/yellowpaper,pdf, such, for example, Byzantium Version fadb37b of that document, dated 2018 Mar. 20, the contents of which are herein incorporated by reference in their entirety.

A blockchain may be used to provide a tamperproof or tamper resistant digital ledger that is distributed amongst the nodes participating in the blockchain system. Such a distributed ledger may be used to provide a cryptographic currency (“cryptocurrency”) such as may be to represent value. In some implementations, resources allocated in accordance with subject matter of the present application may include a cryptocurrency. Examples of cryptocurrencies include Bitcoin and Ether, the latter of which is associated with Ethereum.

A smart contract allows code to be published an executed by nodes participating in a blockchain. For example, Ethereum provides a programming language that is nearly Turing-complete and which can operate on its blockchain. In some implementations, it may be that the subject matter of the present application is implemented using one or more smart contracts. In a particular example, some of all of the functionality of the resource allocation system 300 may be implemented against a block chain. In some such implementations, some or all of the functionality of that system may be provided by a computer system (e.g., a server) that is a node participating in a blockchain network executing a smart contract. For example, smart contracts may correspond to or be triggered by events matching one or more event conditions.

In some implementations implemented using a blockchain, allocated resources may be drawn from a pool or “digital wallet”. For example, it may be that a blockchain is employed to represent transfers of resources from such a pool. Put differently, in some such implementations, resource(s) allocated for a period may be accrued in association with a particular account using a blockchain transaction that updates a distributed ledger to reflect accrual of that resource to an address associated with the particular account. In a particular example, resources so allocated may include tokens such as cryptocurrency. Notably, where events are monitored by another computer it may be that such an accrual is performed by a second computer, such as, for example, a node participating in a blockchain network such as may, for example, be executing a smart contract. Such a pool may be populated once when the system is initially deployed. Additionally or alternatively, it may be that the pool is topped up from time to time by an operator or sponsor of the system.

The tokens associated with the blockchain represent future computing resources. That is, when a token is allocated to a particular account, it is encumbered (e.g., with a public key for that account) so that it may only be used by the holder of the private key associated with that account. The holder of the private key may use the token in a transaction in order to consume computing resources associated with the blockchain. For example, a token may be used by its owner to add a record to the blockchain. For example, the token may be transferred (in whole or in part) to a miner who adds a block to the blockchain to have the record included in the blockchain. Since the blockchain is a distributed ledger which has the redundancy of the network, memory resources at numerous locations (e.g., associated with numerous nodes) may be consumed when the block is added to the blockchain. Thus, the token effectively provides the token holder with the right to use future memory resources associated with various nodes of the blockchain network. The token holder may include, in the record that they have added to the blockchain, data or information of various types including, for example, information, a script, or other information. Thus, distributing a token to a user's account has the effect of distributing a future computing resource, namely memory. Further, ownership of a token may also allow the token holder to use processing resources associated with the blockchain network. For example, the token holder may use the token to cause one or more nodes associated with the blockchain network to do computations.

Resources (such as tokens) may be transferred from a digital wallet associated with the pool to a digital wallet associated with a particular account to which resources are being allocated. In other words, allocating a selected quantity of resources using a blockchain may include initiating a blockchain transaction to indicate the selected quantity of resources are now associated with an address associated with the particular account (e.g., an address of a digital wallet associated with that account).

In some implementations, particular technologies provided in association with a particular blockchain implementation may be employed to provide additional functionality and/or to improve performance. For example, it may be that functionality such as, for example, an Ethereum state channel is utilized to allow portions of resource allocation to a particular user to be performed off-chain. Conveniently, in this way, transaction overhead may be reduced. For example, overhead of transaction fees for cryptocurrency resources may be reduced if portions of the resource allocation occur “off chain”. In a particular example, an Ethereum state channel could be opened between a digital wallet of a user (i.e. used to “store” resources associated with that account) and a digital wallet or pool of a sponsor.

A particular example of an implementation of the subject matter of the present application using a blockchain such as the Ethereum block chain will now be described.

It may be that the system is configured with each account having a corresponding Ethereum digital wallet. The pool of resources to be allocated may correspond to a digital wallet of a system operator or sponsor. Where there is more than one pool of resources associated with different sponsors such as was described above, it may be that there is a digital wallet associated with each. If state channels are employed such as, for example, to reduce the overhead of having each transaction occur on the blockchain one or more state channels may be opened between the digital wallet of an account and resource pools. Avoiding having every resource allocation correspond to a transaction occurring on the blockchain may reduce overhead due to latency and/or due to transaction fees such as, for example, fees for “gas” in Ethereum.

The functionality of some or all of at least the resource allocation component 340 may be implemented by one or more Ethereum smart contracts. For example, such smart contracts may serve to allocate transfer units of value such as, for example, ether or, additionally or alternatively, some other cryptocurrency such as may, for example, be represented or exchanged using Ethereum. In particular, a smart contract may, responsive to information about events associated with a particular account, have the effect of triggering a blockchain transaction adjusting the modifier associated with that account and/or associating a modifier with a particular account for a current period or for a particular duration starting from a particular time. For example, it may be that the account modifier for a particular account for particular period is determined based on the modifiers in effect for that account during that period. Modifiers may be combined in manners described above such as, for example, by multiplication.

Data associated with such a smart contract may encompass the functionality of one or both of the event condition store 360 and the condition-modifier store 380. For example, in some implementations, data stored in one or both of the event condition store 360 and the condition-modifier store 380 may be manifested as state data such as may be stored in an Ethereum Patricia tree. Additionally or alternatively, data associated with the event condition store 360 and/or the condition-modifier store 380 may be stored off chain and accessed by the smart contracts.

The functionality of the event monitoring component 320 may also be provided using the blockchain such as, for example, by way of one or more smart contracts. Alternatively, the event monitoring component may be external to the blockchain and may, for example, operate as a trusted oracle. In some implementations, the implementation of the functionality of the event monitoring component 320 may push information about events to an event store 330 implemented on a blockchain. For example, the event store 330 may be stored as state data in an Ethereum Patricia tree. Additionally or alternatively, the event store 330 may be stored off-chain such as, for example, in a database as described above.

In some embodiments such as, for example, embodiments implemented (in whole or in part) with or using a blockchain, at least some of the events associated with the accounts may be events occurring on the blockchain.

Conveniently, implementations utilizing a blockchain such as, for example, Ethereum may be distributed. Additionally or alternatively, such implementations may be auditable and/or verifiable by third parties. Conveniently, third party audit and/or verification may increase user trust and/or the willingness of users to rely on the system for the allocation of resources. Additionally or alternatively, third party audit and/or verification of an implementation (or allowing for same) may increase the willingness of users and/or third parties to participate in or rely on the resource allocation system. For example, it may be that third parties will be more willing to contribute to or utilize such a resource allocation system.

As noted above, it may be that various ones of the components are software running on more than one computer system such as may communicated thereamongst and/or with the computer system 100 via a computer network (not shown). For example, as noted above, first computer system may be adapted for monitoring events associated with accounts to identify events associated with the accounts and may provide some or all of the functionality of the event monitoring component 320 while a second computer system may be in communication with such a first computer system such as, for example, by way of a network and may be adapted for periodically accruing resources in association with the accounts and may provide some or all of the functionality of the resource allocator component 340. Conveniently, in some embodiments, the second computer system may be a node participating in a blockchain such, as for example, a node executing a smart contract.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments and implementations can be made. Therefore, the above discussed embodiments and implementations are considered to be illustrative and not restrictive.

What is claimed is:

1. A computer system comprising:
a processor;
a network interface module; and
a computer-readable medium storing instructions, the computer system being a node participating in a blockchain network executing a smart contract, wherein the instructions when executed by the processor, adapt the computer system to:
identify, from amongst a plurality of event conditions, event conditions matched by events associated with an account, the events having been identified based on a monitoring of events associated with the account;
retrieve modifiers associated with the matched event conditions;
compute an account modifier based on the retrieved modifiers; and
allocate a selected quantity of resources for use in association with the account, wherein the selected quantity of resources is determined by modifying a base resource level based on the account modifier, the allocating including initiating a blockchain transaction to update a distributed ledger to indicate the selected quantity of resources in association with an address associated with the account,
wherein one or more of the events are associated with consumption of computing resources and wherein the modifiers associated with particular event conditions are updateable based on a comparison of computing resources consumed by events matching the particular event conditions with a resource allocation for those events.

2. The computer system of claim 1 wherein the instructions when executed by the processor further adapt the computer system to:
detect a previously defined consumption of computing resources;
identify one or more events associated with the previously defined consumption of computing resources; and
adjust modifiers associated with event conditions matching the one or more events associated with the previously defined consumption of computing resources.

3. The computer system of claim 2 wherein adjusting modifiers associated with event conditions matching one or more events associated with the previously defined consumption of computing resources includes adjusting at least one of the modifiers to a fractional value.

4. The computer system of claim 1 wherein the retrieved modifiers are multipliers.

5. The computer system of claim 1 wherein computing the account modifier based on the retrieved modifiers includes computing a product of the retrieved modifiers.

6. The computer system claim 1 wherein the events associated with the account are events that occurred since a last allocation of resources for use in association with the account and wherein the account modifier is further computed based on modifiers associated with event conditions matched by events prior to the last allocation of resources.

7. The computer system of claim 1 wherein each of the retrieved modifiers has an associated activation period and wherein the account modifier is computed based on ones of the retrieved modifiers that are active based on their respective activation periods.

8. The computer system of claim 1 wherein one or more event conditions matching events associated with a previously defined consumption of computing resources have associated modifiers with fractional values.

9. The computer system of claim 1 wherein one or more event conditions matching events associated with a previously defined consumption of computing resources have associated modifiers with values greater than or equal to one.

10. The computer system of claim 1 wherein information about events associated with the account is retrieved from a remote computing device via a network using the network interface module.

11. A computer-implemented method performed by a node participating in a blockchain network executing a smart contract, the method comprising:
identifying, by a processor of a computing device from amongst a plurality of event conditions, event conditions matched by events associated with an account, the events having been identified based on a monitoring of events associated with the account;
retrieving modifiers associated with the matched event conditions;
computing, by the processor, an account modifier based on the retrieved modifiers; and
allocating a selected quantity of resources for use in association with the account, wherein the selected quantity of resources is determined by modifying a base resource level based on the account modifier, and wherein the allocating includes initiating a blockchain transaction to update a distributed ledger to indicate the selected quantity of resources in association with an address associated with the account,
wherein one or more of the events are associated with consumption of computing resources and wherein the modifiers associated with particular event conditions are updateable based on a comparison of computing resources consumed by events matching the particular event conditions with a resource allocation for those events.

12. The method of claim 11 further comprising:
detecting a previously defined consumption of computing resources;
identifying one or more events associated with the previously defined consumption of computing resources; and
adjusting modifiers associated with event conditions matching the one or more events associated with the previously defined consumption of computing resources.

13. The method of claim 12 wherein adjusting modifiers associated with event conditions matching the one or more events associated with the previously defined consumption of computing resources includes adjusting at least one of the modifiers to a fractional value.

14. The method of claim 11 wherein the retrieved modifiers are multipliers.

15. The method of claim 11 wherein computing the account modifier based on the matched event conditions includes computing a product of the retrieved modifiers.

16. The method of claim 11 wherein the events associated with the account are events that occurred since a last allocation of resources for use in association with the account and wherein the account modifier is further computed based on modifiers associated with event conditions matched by events prior to the last allocation of resources.

17. The method of claim 11 wherein each of the retrieved modifiers has an associated activation period and wherein the account modifier is computed based on ones of the retrieved modifiers that are active based on their respective activation periods.

18. The method of claim 11 wherein one or more event conditions matching events associated with a previously defined consumption of computing resources have associated modifiers with fractional values.

19. The method of claim 11 wherein one or more event conditions matching events associated with a previously defined consumption of computing resources have associated modifiers with values greater than or equal to one.

20. A non-transitory computer-readable storage medium storing instructions that, when executed by a processor of a computing device that is a node participating in a blockchain network executing a smart contract, cause the computing device to:
identify, from amongst a plurality of event conditions, event conditions matched by events associated with an account, the events having been identified based on a monitoring of events associated with the account;
retrieve modifiers associated with the matched event conditions;
compute an account modifier based on the retrieved modifiers; and
allocate a selected quantity of resources for use in association with the account, wherein the selected quantity of resources is determined by modifying a base resource level based on the account modifier, the allocating including initiating a blockchain transaction to update a distributed ledger to indicate the selected quantity of resources in association with an address associated with the account,
wherein one or more of the events are associated with consumption of computing resources and wherein the modifiers associated with particular event conditions are updateable based on a comparison of computing resources consumed by events matching the particular event conditions with a resource allocation for those events.
